(19) United States
(12) Patent Application Publication
(10) Pub. No.: US 2010/0230417 A1
(43) Pub. Date: Sep. 16, 2010

(54) VESSEL FOR A COMPRESSED GAS AND METHOD FOR PRODUCING THE VESSEL

(75) Inventor: Kurt Berglund, Norrfjarden (SE)

Correspondence Address: PEARNE & GORDON LLP, 1801 EAST 9TH STREET, SUITE 1200, CLEVELAND, OH, 44114-3108, US

(73) Assignee: Gastank Sweden AB, Norrfjarden (SE)

(21) Appl. No.: 12/740,180

(22) PCT Filed: Oct. 31, 2007
(86) PCT No.: PCT/SE07/50802

§ 371 Date: May 21, 2010

(51) Int. Cl. B65D 90/02; B29C 53/64

(52) U.S. Cl. 220/565; 156/172; 156/425

(57) ABSTRACT

The present invention relates to a vessel for a compressed gaseous fuel. The vessel has a non-cylindrical shape and is provided with a bulk head within the vessel. The vessel is surrounded by a composite comprising a fibre reinforcement that is wound around the vessel. The vessel comprises a liner with a shape that is substantially the same as the desired vessel shape. The liner is provided with at least one recess that extends around the liner and divides the liner in sections connected to each other by a passage. The fibre reinforcement is continuously wound around the liner in different directions to ensure sufficient vessel strength and the recess is filled with fibres so that the fibres in the recess constitute the bulk head. The invention further relates to a method for producing the claimed vessel.

### TECHNICAL FIELD OF THE INVENTION

The present invention relates to a vessel for a compressed gas, a method for producing the vessel and a production plant.

### BACKGROUND OF THE INVENTION

Different types of gas are used in a number of different applications. The gas is normally enclosed in a high pressure vessel designed to withstand the pressure from the gas in the vessel. The pressure can, depending on the application, temperature, amount of gas in the vessel and the specific type of gas, reach a considerable pressure and the pressure vessel must therefore be designed accordingly.

There are a number of different pressure vessels available. Most of them have a cylindrical shape with a circular cross section since a pressure vessel with cylindrical shape, circular cross section and sufficient strength is considerably easy to produce. The vessel is either made of metal, or a composite comprising a fibre reinforcements would around a mandrel alternatively around a liner.

Today an increasing number of vehicles are powered by, for example, a compressed natural gas (CNG) or a biogas. In order to ensure the desired operating range for the vehicle, the volume of the vessel must be sufficiently large. The space available in a vehicle is however very limited, and in order to increase the vessel volume a vessel with a non-cylindrical shape and non-circular cross section that could be adapted to the available space is required.

The loads in a vessel with a non-cylindrical shape, and non-circular cross section, are however considerably different, and larger, than in a vessel with a cylindrical shape and circular cross section. In order to make the vessel strong enough to withstand the loads, the vessel could be provided with bulk heads placed inside the vessel. The bulk heads reduces the stresses in the vessel. A fibre reinforced pressure vessel with a non-cylindrical shape and an internal bulk head is disclosed in WO 2007/106035.

The disclosed vessel is manufactured in pieces that are put together to the final vessel shape.

The object of the present invention is to provide a fibre reinforced vessel with a non-circular cross section that is produced in one piece.

### SUMMARY OF THE INVENTION

The present invention relates to a pressure vessel according to claim 1, a method according to claim 7 for producing said vessel, and a production plant according to claim 13.

The claimed vessel has a non-cylindrical shape and is provided with a bulk head within the vessel. The vessel is surrounded by a composite comprising a fibre reinforcement that is wound around the vessel. The vessel comprises a liner with a shape that is substantially the same as the desired vessel shape. The liner is provided with at least one recess that extends around the liner and divides the liner into sections connected to each other by a connecting portion. The fibre reinforcement consists of fibres continuously wound around the liner in different directions to ensure sufficient vessel strength and that the recess is filled with fibres so that the fibres in the recess constitute the bulk head.

The present invention makes it possible to produce vessels with a non-cylindrical shape and a bulk head in one piece. The shape and size could be adapted for the specific application since the number of bulk heads in the vessel easily could be increased by providing the liner with further recesses and adapt the fibre winding accordingly.

Preferred embodiments of the vessel are shaped like parallelepipeds with rounded edges, for example with a square, triangular or rectangular cross section depending on the available space for the vessel. The vessel is provided with at least one recess that extends around the liner in a plane transverse to the longitudinal direction of the parallelepiped.

The depth of the recess in relation to the width of the vessel is selected so that the connecting portion, comprising a passage connecting the different vessel sections, between the vessels sections divided by the recess might be at least about 50 mm in order to provide sufficient communication within the vessel, and to ensure that the bulk head generated within the recess provides sufficient strength to the vessel.

The sides of the recess are extending in substantially radial direction from the longitudinal axis of the liner, alternatively inclined inwards or outwards. The width of the recess might be between 10 mm and 50 mm, and preferably between 12 mm and 25 mm in order to provide a bulk head with sufficient strength. The recess could also have different dimensions depending on the specific application.

The fibres are either fibres of glass, aramid, carbon or basalt that are wound around each of the liner sections tangentially and axially until the recess is completely filled with fibres. When the recess is filled with fibres, the winding continues and fibres are wound axially around the entire vessel in order to ensure sufficient vessel strength.

The required fibre reinforcement is calculated from the pressure that the vessel must be able to withstand from the gas enclosed in the vessel, the vessel size and the vessel shape. The overall weight of the vessel is preferably kept as low as possible and more fibres than necessary will increase the vessel weight. In order to provide sufficient strength the fibres are wound in both tangential and axial direction on the liner.

The fibres that are wound around the liner are either pre-preg fibres that already are impregnated with a thermoset resin, normally comprising epoxy, or fibres that are wetted in the production plant prior to the application of the fibre onto the liner. In both alternatives, the vessel will be heated after the fibres are applied have been wound around the liner to a specific temperature at which the thermoset resin will cure. The composite will not get full strength until the thermoset resin is fully cured.

The liner is for example made of a thermoplastic material that is blow-shaped in a mould to the desired shape. If the liner is made of a material that makes it leak proof, the fibre reinforcement only provides sufficient strength to withstand the loads from the CNG.

The vessel is manufactured by a method comprising the steps:
rotating a liner provided with at least one recess that extends around the liner and divides the liner into sections connected by a connecting portion,
winding a fibre, or a set of fibres, continuously around each section of the liner,
continue winding until the entire recess is filled with fibres,
winding fibres around the entire liner until the liner is surrounded by enough fibres to ensure sufficient vessel strength,
cure the composite.

If the fibres used not are pre-preg fibres, the fibres are wetted in a thermoset resin before they are winded on the liner.

One preferred embodiment of method for manufacturing a vessel comprises the additional steps below to be performed between steps 2 and 3:
holding the fibre, or set of fibres, with holding means close to an edge between the outer periphery of the liner and the side of the recess,
rotating the liner at least about 60° during continued winding of the fibre, or set of fibres, in the recess.

The additional steps include the use of holding means that secure the fibres in the intended position at the edge between the periphery of liner and the side of the recess. This additional step ensure that the fibre remain in the intended position and not slip when the winding is continued in the recess. Otherwise there is a considerable risk that the fibre, or fibres, slip in this area due to the continuous rotation of the liner and the changed angle of the fibre around the edge.

The holding means keeps the fibres in the intended position until the liner has rotated at least 60°. When the liner has turned the specified angel, no forces acting sideways on the fibres remain due to the rotation of the liner and the holding means are no longer needed, and are consequently withdrawn to be used the next time the fibres are passing the edge between periphery of the liner and the side of the recess.

In a further preferred embodiment of the method, step 2 comprises the step of first providing each section with tangentially wound fibres, followed by axially wound fibres.

In a further preferred embodiment of the method, the axial winding is applied in such a way that the angle between the longitudinal direction of the fibres and the longitudinal axis of the liner might be between 10° and 60° in order to ensure sufficient vessel strength and low overall weight.

In a further preferred embodiment of the method the fibres wound around the liner in step 4 are applied in such a way that the angle between the longitudinal direction of the fibres and the longitudinal axis of the liner might be between 5° and 40° in order to ensure sufficient vessel strength and low overall weight.

The present invention also relates to a production plant for producing the claimed vessel with the claimed method. The production plant comprises means for securing and rotating a liner, and means for applying a fibre, or a set of fibres, on the rotating liner

In one preferred embodiment of the production plant, the means for applying a fibre, or set of fibres, is an industrial robot that is movable along at least seven different axes.

Another preferred embodiment for use in combination with the preferred production method further comprises means for holding the fibre, or set of fibres, in a position close to the edge between the periphery of the liner and the side of the recess.

In another preferred embodiment of the production plant said holding means is an industrial robot that is movable along at least six different axes.

The production plant and the different means within the production plant are preferably controlled by computers and computer programs.

### BRIEF DESCRIPTION OF THE DRAWINGS

One embodiment of the invention is disclosed in the appended drawings, in which:

FIG. 1a Illustrates a perspective view of a liner according to the present invention.

FIG. 1b Illustrates a cross-section of the liner in FIG. 1a through line A-A.

FIG. 2a Illustrates a side view of the liner provided with tangentially wound fibres.

FIG. 2b Illustrates a cross section through line AI-AI in FIG. 2a.

FIG. 3a Illustrates a perspective view the liner in FIG. 1a provided with axially winded fibres around one section of the liner.

FIG. 3b Illustrates a side view of the liner in FIG. 3a in which the axial winding angle illustrated.

FIG. 3c Illustrates a cross section through liner B-B in FIG. 3b.

FIG. 4 Illustrates a side view of the overall axial winding of entire vessel.

### DETAILED DESCRIPTION OF THE INVENTION

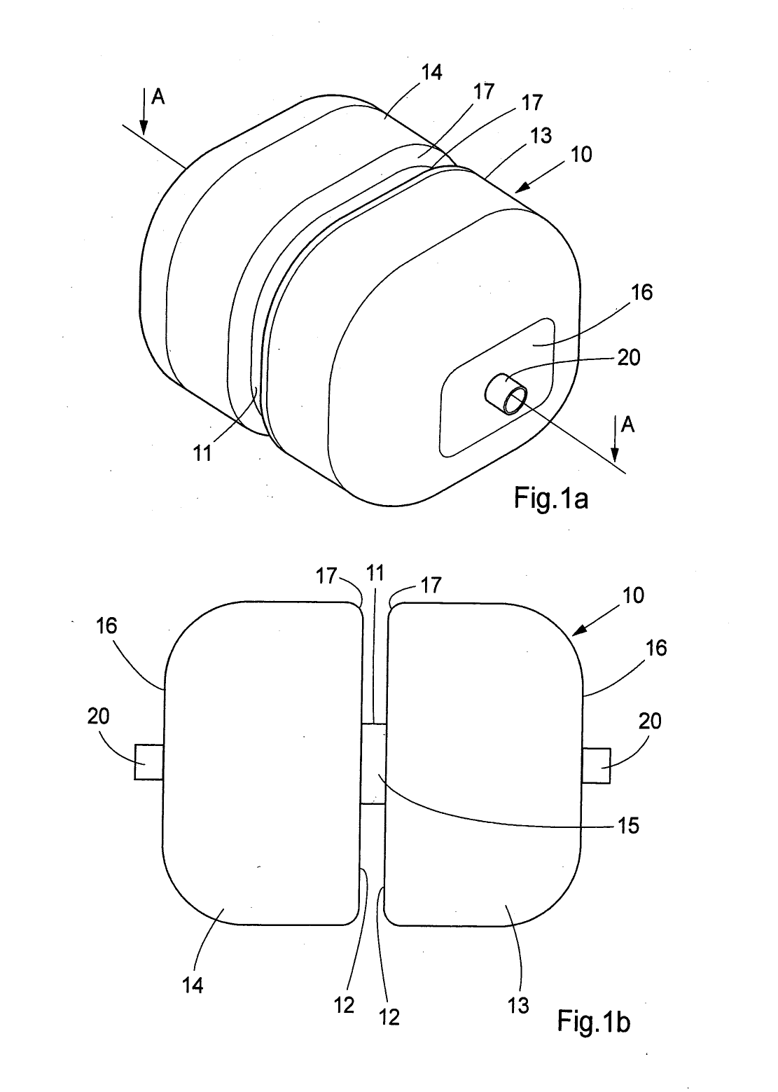

In FIGS. 1a and 1b one embodiment of a liner 10 for use in a vessel according to the present invention is disclosed. The liner 10 is a parallelepiped with substantially square cross section. The liner 10 is provided with a recess 11 placed close to the longitudinal centre of the liner 10. The recess 11 extends in radial direction into the liner 10 but the two sections 13 and 14 divided by the recess 11 are connected by a connecting portion 15 in the centre of the liner 10. The recess 11 has two sides 12 that extend in substantially radial direction from the longitudinal axis of the liner 10. The sides could however also be inclined inwards or outwards.

The connecting portion 15 between the different sections 13 and 14 of the liner 10 comprises a passage that connects the interior of the different sections 13 and 14 with each other. The connection portion 15 has a circular cross section, but could also have other cross sectional shapes like square, triangular etc. The cross sectional shape should however not have concave sections in order to provide support for the fibres wound around the connecting portion 15.

Both ends 16 of the parallelepiped are rounded as well as the edges 17 between the periphery of the liner 10 and the sides 12 of the recess 10. Each end 16 of the liner 10 are provided with an adapter 20 that provides access to the vessel and are used for securing and rotating the liner 10 during production.

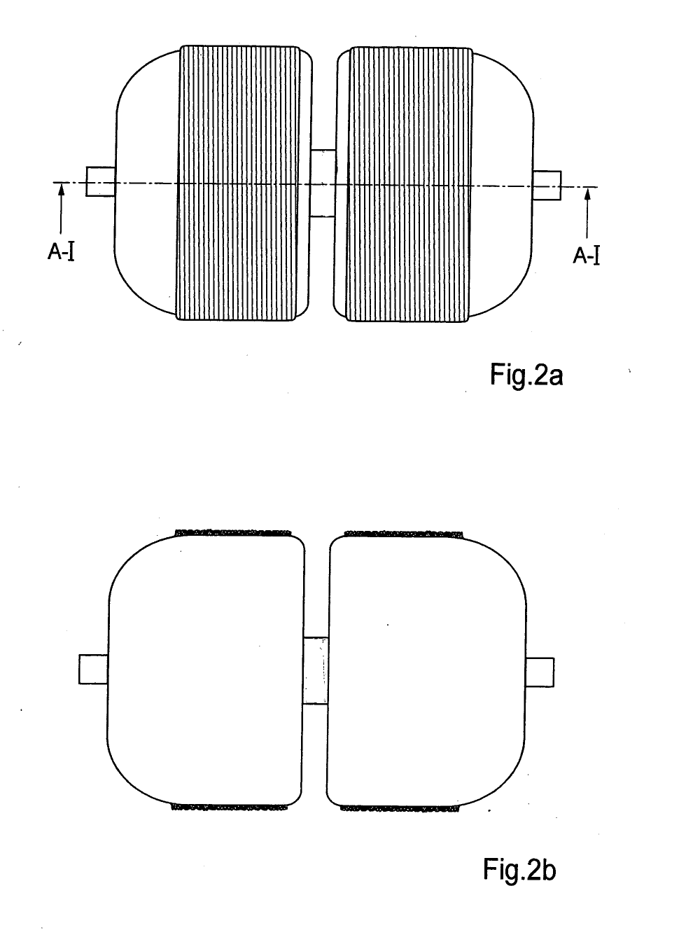

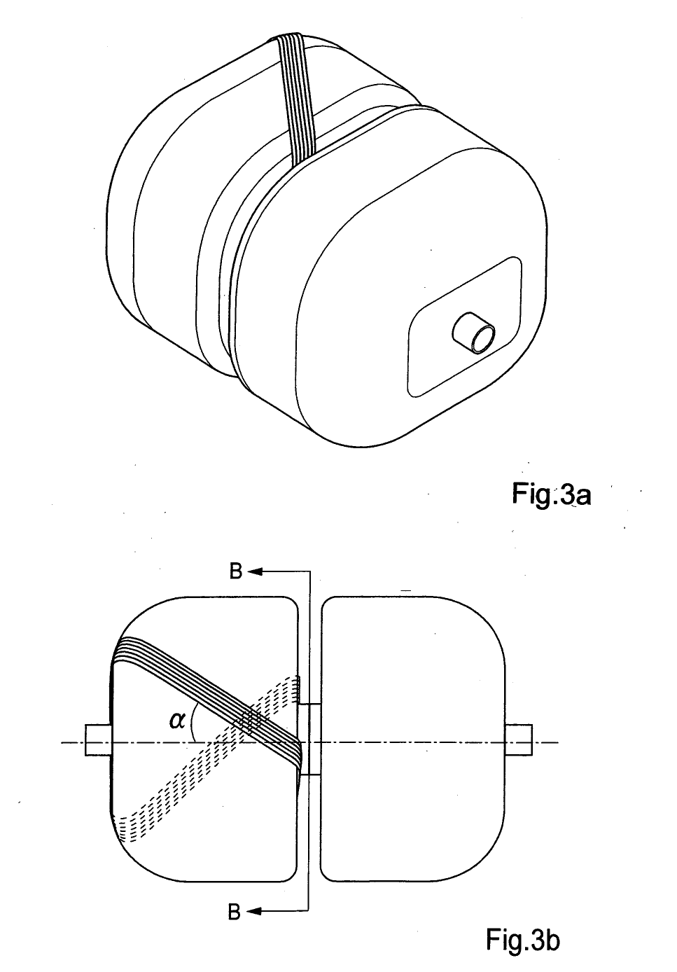

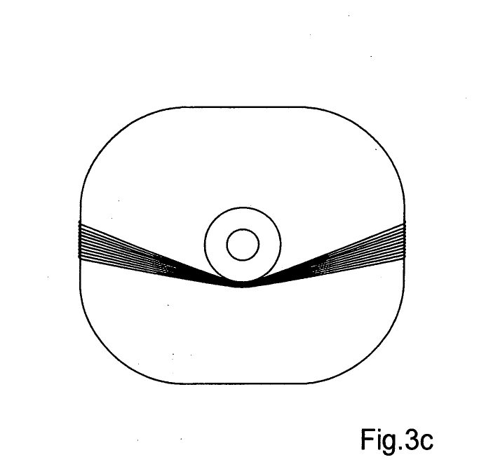

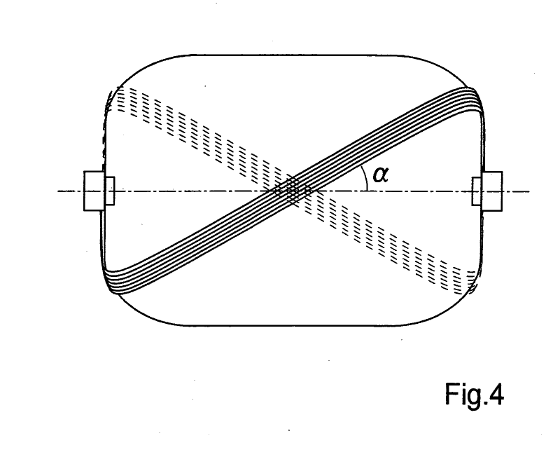

During production of the vessel the liner 10 is arranged in a production plant where it is rotated, and a fibre, or set of fibres are wound around the liner. First, fibres wound in tangential direction around each of the sections 13 and 14 are provided. The tangentially wound fibres are illustrated in FIGS. 2a and 2b.

Secondly, fibres are wound in axial direction around each of the sections 13 and 14. The fibre, or set of fibres, is wound around the section in predetermined direction in relation to the longitudinal direction of the liner.

The angle a between the longitudinal direction of the fibre and the longitudinal direction of the liner 10 is between approximately 10° and 60° depending on the required vessel strength and the particular application for the vessel.

When the fibre, or set of fibres, reach the edge 17 between the periphery of the liner 10 and the sides 12 of the recess 10 the winding continues essentially radially along side 12 of the recess towards the bottom of the recess 11. The rotation of the liner 10 is continued and the fibre is wound around a section of the passage 15 between the vessel sections 13 and 14 before it continues outwards along side 12, around edge 17 and then axially along the periphery of the same section towards the end 16 of the liner where it continues around the rounded end 16 along a geodetic line and begins the next winding loop around the section. Each section 13 and 14 is wound separately and the winding continues until the entire recess 11 is completely filled with fibres or sufficient strength is achieved in the axial winding around the section.

The fibres are wound around the rounded edge 17 and continue along the recess side 12 towards the connecting portion 15 between the vessel sections 13 and 14. The liner is however rotating continuously and there is a considerably risk that the fibres slip along the edge 17 away from the intended correct position for the fibres. The production plant where the vessels are produced comprises a fastening and rotating means for the liner and a device that controls the positioning of the fibres during winding. This is preferably done by an industrial robot that is at least movable along seven axes. In order to prevent the fibres from slipping from the intended correct position along edge 17 a holding device could be used. The holding device has a substantially straight holding edge that is used to press the fibre, set of fibre towards the liner and prevent the fibre, or set of fibres from slipping. The holding device is no longer needed when the fibre has passed the connecting portion 15 since no further side forces are acting on the fibre at the edge 17 once the fibre has been wound passed the connecting portion 15, and the holding device is therefore removed to be ready to hold the fibre when it passes the edge 17 at the next winding loop. The liner is at least rotated about 150° with the holding device acting on the fibre, or set of fibres.

There is no need for the holding device when the fibre is coming from the connecting portion 15 over the edge 17 since it is then wound along a geodetic line and there is no risk for the fibre, or set of fibres, slipping.

The holding device is preferably controlled by an industrial robot that is at least movable along seven axes.

If necessary, after the necessary axial winding around each of section 13 and 14 has reached the desired strength, tangential winding is used to fill up the recess 11. Once the recess 11 is completely filled with fibres, the vessel is axial wound with fibres extending al the way around the vessel.

The fibres are either pre-preg fibres that are impregnated with a thermoset resin or wetted in a thermoset resin before they are wound around the liner/vessel. When all fibres are wound onto the liner, the thermoset resin is cured and the composite reaches its full strength. The fibres that are placed in the recess 11 will after they have been cured provide a bulk head in the vessel. The bulk head increases the vessel strength considerably, and are necessary to provide sufficient vessel strength in a vessel with a non-cylindrical shape. The curing is initiated by increasing the temperature to a specific temperature for the thermoset resin.

Vessel according to the present invention could be shaped in many different shapes and sizes since larger vessels could be divided into further sections divided by additional recesses. Furthermore the pre cross-section of the vessel could have many different shapes like for example, rectangular or triangular as long as the periphery not has concave sections, since the concave surfaces would make the winding more complicated.

The liner is used as the mandrel for the winding process and if the liner is not strong enough to withstand the loads from the fibres, air could be pumped into the liner so that the pressure from the air makes the liner more resistant.

The present invention should not be limited to the described embodiments, since these embodiments only serves as examples falling within the scope of the invention defined by the appended claims.

1. Vessel for a compressed gaseous fuel, the vessel has a non-cylindrical shape and is provided with a bulk head within the vessel, the vessel is surrounded by a composite comprising a fibre reinforcement that is wound around the vessel characterized in that the vessel comprises a liner with a shape that is substantially the same as the desired vessel shape, said liner is provided with at least one recess that extends around the liner and divides the liner in sections connected to each other by a connecting portion, said fibre reinforcement is continually wound around the liner in different directions to endure sufficient vessel strength and that the recess is filled with fibres so that the fibres in the recess constitute the bulk head.

2. Vessel according to claim 1, wherein the vessel is shaped like a parallelepiped with rounded edges and the at least one recess is extending around the liner in a plane transverse to the longitudinal direction of the parallelepiped.

3. Vessel according to claim 1, wherein the depth of the recess in relation to the width of the vessel is selected so that the connecting portion between the vessel sections divided by the recess is at least 5 cm.

4. Vessel according to claim 1, wherein the sides of the recess are either extending in a substantially radical direction for the longitudinal axis of the liner or inclined inwards or outwards, and the width of the recess is between 10 mm and 50 mm, and preferably between 12 mm and 25 mm.

5. Vessel according to claim 1, wherein the fibres are either fibres of glass, aramid, carbon or basalt that are wound tangentially and axially around each of the liner sections until the recess is completely filled with fibres, before fibres are wound axially around the entire vessel.

6. Vessel according to claim 1, wherein the fibres either are pre-preg fibres or wetted in a thermostat resin, normally comprising epoxy before they are wound on the liner.

7. Method for manufacturing a fibre reinforced composite vessel with a non-cylindrical shape according to claim 1, comprising the steps:
a) rotating a liner provided with at least one recess that extends around the liner and divides the liner into sections connected by a connecting portion,
b) winding a fibre or a set of fibres, continuously around each section of the liner,
c) continue winding until the entire recess is filled with fibres,
d) winding fibres around the entire liner until the liner is surrounded by enough fibres to ensure sufficient vessel strength,
e) cure the composite.

8. Method according to claim 7, wherein the fibres are wetted in a thermostat resin before they are winded on the liner.

9. Method according to claim 7, comprising the additional steps to be performed between steps b and c:
f) holding the fibre, or set of fibres, with holding means close to an edge between the outer periphery of the liner and the sides of the recess,
g) rotating the liner at least about 60° during continued winding of the fibre, or set of fibres, in the recess.

10. Method according to claim 7, wherein step b) comprises the step of first providing each section with tangentially wound fibres followed by axially wound fibres.

11. Method according to claim 7, wherein the axial winding is applied in such a way that the angle between the longitudinal direction of the fibres and the longitudinal axis of the liner is between 10° and 60°.

12. Method according to claim 7, wherein the fibres wound around the liner in step d) is applied in such a way that the angle between the longitudinal direction of the fibres and the longitudinal axis of the liner is between 5° and 40°.

13. Production plant for producing a vessel according to the method according to claim 7, comprising means for securing and rotating a liner, means for applying a fibre, or a set of fibres, on the rotating liner.

14. Production plant according to claim 13, wherein the means for applying a fibre, a set of fibres, is an industrial robot that is at least movable along 7 axes.

15. Production plant for producing a vessel according to the method defined in claim 9, further compromising means for holding the fibre, or set of fibres, in a position close to the edge between the periphery of the liner and the side of the recess.

16. Production plant for producing a vessel according to the method defined in claim 9, wherein said holding means is an industrial robot that is at least movable along six axes.
